(19) United States
(12) Patent Application Publication
(10) Pub. No.: US 2004/0201726 A1
(43) Pub. Date: Oct. 14, 2004

(54) Digital camera and method for balancing color in a digital image

(76) Inventors: Daniel M. Bloom, Loveland, CO (US); Wilfred F. Brake, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/100,142

(22) Filed: Mar. 19, 2002

(51) Int. Cl. H04N 9/73

(52) U.S. Cl. 348/223.1

(57) ABSTRACT

A digital camera and method is disclosed having functions for color balancing of digital images by allowing a user to manually adjust the color balance of a scene or image before capturing the final image. A sensor senses the image and sends it to an image processor for color balancing. While the image is displayed on the display, the user can adjust the color balance in real time by manipulating the user input device, which affects color balance parameters used by the image processor. After completion of color balancing, the user captures a final image using a shutter control. The image processor then applies the adjusted color balance parameters to the captured image. One embodiment adjusts the color balancing on a low resolution image and then applies the final color balance parameters to the captured image. The color balance may be adjusted using a color balance menu displayed on the display.

### BACKGROUND

In the field of digital photography, achieving a desired color balance of a digital image is difficult. Just as shining a red light bulb onto a white paper would make the paper appear red, so do different natural and artificial lighting conditions affect the appearance of objects illuminated by such light. For example, an early morning sun illuminates objects differently than a mid-day sun, or a sunset. A sunset may produce reddish tones while an early morning sun may produce bluish tones. Likewise, artificial light sources such as florescent and incandescent light bulbs produce still different lighting conditions. A tungsten bulb may produce a different lighting condition than other types of bulbs.

The human brain adjusts automatically to compensate for different illuminants. In most lighting conditions, a white piece of paper will appear white to the human eye. Minor illuminant variations generally go unnoticed by the human eye even though they would significantly affect a digital or film-based camera image. In this sense, the human brain has its own color balance.

Users of conventional film-based cameras have struggled with color balance. The problem may be partially alleviated by using different types of film. Still, film-based cameras often fail to capture the scene as seen by the photographer. For example, after having the film developed, the photographer may discover a reddish tint to those photographs taken in a warm light.

Conventional digital cameras present advantages and disadvantages relative to color balance. Digital cameras allow variable color balancing, because there is no film to change. Some digital cameras use a 3×3 color-balance matrix to modify the color balance of an image. An image sensor captures the image and filters red, blue, and green color signals for pixels in the image. The color signals (R, B, G) are digitized and passed through the color balance matrix to produce color-balanced signals (R′, B′, G′). The parameters of the matrix are fixed for one or more known lighting conditions.

Various methods of digital color balancing may be used. In general, existing algorithms first attempt to automatically identify an illuminant. Different illuminants affect the color balance differently, in a known manner. Once the illuminant is determined, the algorithms can adjust the color balance based on the known properties of the identified illuminant. The primary algorithms are grayworld, maximum RGB, and color by correlation.

The grayworld algorithm is an older method that assumes the average color in a scene is gray, and that deviations from this average are caused by the illuminant. The grayworld algorithm drives red, blue, and green components based on average values. The grayworld algorithm has various limitations, including the most obviously flawed assumption—that not every scene has an average value of red, blue, and green color components. For example, a scene having more blue components will not be properly color balanced using the grayworld method alone.

The maximum RGB method identifies a white object in the scene. It then drives the color of this object to white as the baseline and normalizes all other colors based on the baseline. It may also identify the maximum red, blue, and green pixels detected in the image and drive those colors to the maximum color values, while adjusting intermediate colors accordingly. Some cameras implement this method to identify the illuminant, and then adjust the other colors based on the detected illuminant. The camera may identify the illuminant based on the change required to manually set the white object baseline or the maximum RGB. Different illuminants may require different changes to these colors, and the camera may adjust the entire image once it has identified the illuminant. This algorithm likewise has limitations. For example, a scene without a pure white object is difficult to balance. Also, a scene having multiple illuminants, such as a room with both incandescent and fluorescent lights, may be difficult to properly balance.

Color by correlation is a more advanced method that considers all of the colors in the scene and attempts to identify an illuminant based on those colors. Certain colors appear or do not appear under certain illuminants. For example, a very deep blue color will never appear under a halogen illuminant because a fully blue response cannot appear when a slightly reddish halogen light shines on a blue object. If this deep blue color is detected by the camera in a scene, then the camera knows that the illuminant is not a halogen light. Using a process of elimination and probabilities, the color by correlation algorithm identifies the likely illuminant. Once the illuminant is determined, the color is balanced based on a pre-defined color balancing formula that compensates for that illuminant. The color by correlation method is also limited, for example, in analyzing scenes that do not have a variety of colors. For example, in a scene that is substantially blue, the color by correlation method may be unable to determine the illuminant with any degree of certainty, because the colors in the scene do not allow elimination of all possible illuminants.

Some digital cameras include multiple, pre-defined color balance settings that are selected manually before taking a photograph. For example, settings may be available for lighting that is sunny, incandescent, fluorescent, cloudy, etc. Each of these settings modifies the color signals received by the camera. Before taking a picture, the user may select one of these settings. These systems also have difficulty balancing color in lighting conditions involving multiple illuminants. They further have the limitation of forcing the user to select a discrete, pre-defined color balance setting that might not accurately balance the color.

Existing color balance methods all have shortcomings based on the assumptions they make. Some methods require a white surface or assume an even distribution in a scene. Other methods fail to properly balance color in conditions involving multiple illuminants. What is needed is a digital camera that provides better color balance of images. What is also needed is a method of more accurately balancing color in a digital camera.

### SUMMARY

A digital camera is disclosed having functions for color balancing of digital images. The camera allows a user to manually adjust the color balance of a scene or image before capturing the final image. The camera includes sensor for sensing an image, an image processor that color balances the sensed image, a display that displays the image, and a user input device, such as a four-way rocker switch, for adjusting the color balance of the image while it is displayed on the display. Before the image is captured, the image is sensed by a sensor and sent to the image processor for processing, including color balancing. While the image is displayed on the display, the user can adjust the color balance by manipulating the user input device, which affects color balance parameters used by the image processor. After completion of color balancing, the user captures a final image using a shutter control. The image processor then applies the adjusted color balance parameters to the captured image, and the color-balanced image is stored in memory.

A method is also disclosed for balancing color in a digital camera using an interactive mode to adjust the color balance and a capture mode to capture an image and apply the adjusted color balance to the image. An interactive mode allows the user to modify color balance parameters while viewing the image on a display. When the color balance parameters are set, the user activates a shutter control that captures the image. The captured image is processed by an image processor that applies the color balance parameters to the image.

A method is also disclosed for adjusting color balance of a digital image by sensing a low resolution image and processing the low resolution image to adjust color balance. The low resolution image is displayed on a display. While the image is displayed, a signal is received from a user input device manipulated by a user to adjust the color balance. Based on the received signal, the color balance parameters used to balance the color are adjusted, and the low resolution image is again processed to balance the color based on these new parameters.

A digital camera is also disclosed that allows a user to manually adjust color balance in an interactive mode, to capture an image, and to then apply the adjusted color balance settings to the captured image. The camera includes a sensor that senses a low resolution image in interactive mode and a full image in capture mode. An image processor color balances the low resolution image in interactive mode and color balances the full image in capture mode. A user input device is used to adjust the color balance of the image in interactive mode by sending a signal to the image processor. A display displays the low resolution image in real time as the user adjusts the color balance with the user input device. A shutter control is used to capture the image when the color balancing is complete.

### DESCRIPTION OF THE DRAWINGS

The detailed description will refer to the following drawings, wherein like numerals refer to like elements, and wherein:

FIG. 1 is a perspective view of one embodiment of a digital camera that uses a color balancing method to color balance a captured image.

FIG. 2 is a block diagram of the digital camera of FIG. 1.

FIG. 3 is a flow chart illustrating one method used by the digital camera to color balance images.

FIG. 4 is a flow chart of one embodiment of the color balancing method shown in FIG. 3, as performed during the interactive mode.

FIG. 5 is a flow chart of another embodiment of a color balancing method shown in FIG. 3, as performed during the interactive mode.

FIG. 6 is one implementation of the color balancing method according to the embodiment shown in FIG. 5.

FIG. 7 is a flow chart of a color balancing method performed during an interactive mode.

FIG. 8 is an alternative method of the color balancing method of FIG. 7.

FIG. 9 is another alternative method of the color balancing method of FIG. 7.

FIG. 10 is a flow chart of one embodiment of the color balancing method of FIG. 9.

FIG. 11 is a flow chart of a color balancing method that processes a low resolution image in the interactive mode.

FIG. 12 illustrates one embodiment of a display using an interactive color balance menu.

### DETAILED DESCRIPTION

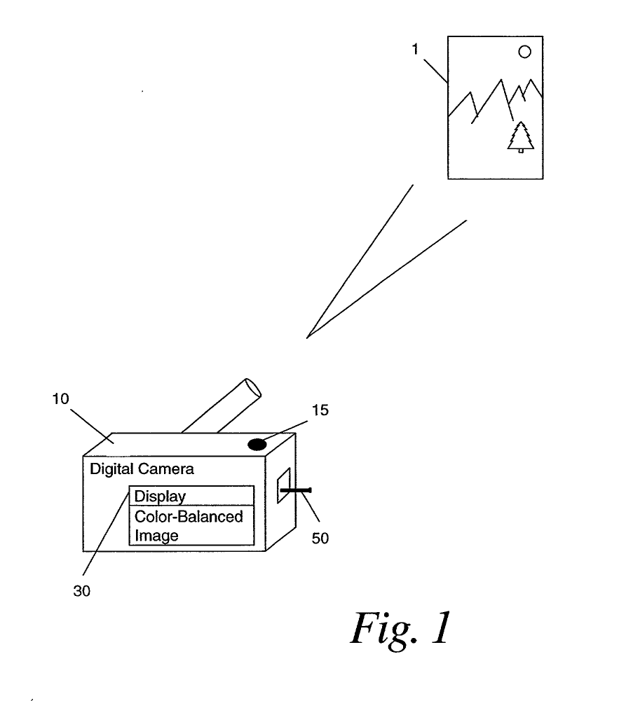

FIG. 1 shows a digital camera 10 that uses a color balance method described herein. The camera 10 includes a sensor (not shown) that detects the image 1 and 14 displays it on the display 30, such as a liquid crystal display (LCD). While viewing the sensed image 1 on the display 30 and before capturing a final image 1, the user 90 can adjust the color balance using a user input device 50, such as a four-way rocker switch, a joy stick, or one or more knobs or controls. The camera 10 uses an image processor (not shown) to adjust the color balance of the image 1. The user input device 50 sends a signal to the image processor modifying the color balance of the image 1 displayed on the display 30, as the image 1 is displayed. This enables the user 90 to view changes to the color balance in real time and to adjust the color balance as needed, before the image 1 is captured and stored to memory. In one embodiment, the user input device 50 modifies the image 1 across a continuous color balance spectrum according to the signal received from the user input device 50, whereby the user 90 may gradually vary the color balance of the image 1 as desired, rather than adjusting only between pre-defined color balance settings. One method of allowing continuous real-time color balancing uses a 3×3 color balance matrix to balance the color of an image 1, and allows the user 90 to vary the matrix parameters as the image 1 is displayed on the display 30 by manipulating the user input device 50. In the embodiment shown in FIG. 1, the user input device 50 and LCD are co-located with, and attached to, the camera 10. After adjusting the color balance, the user 90 uses the shutter control 15 to capture the final image 1. The captured image 1 is processed by the image processor, which adjusts the color balance according to the settings selected by the user input device 50.

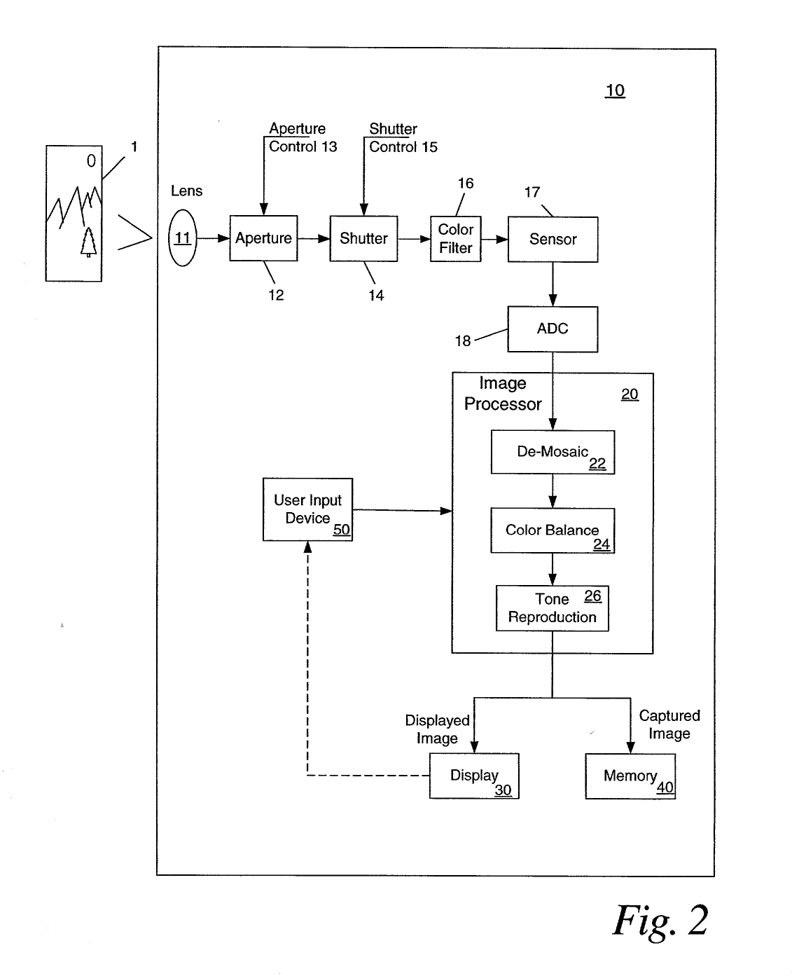

FIG. 2 shows a block diagram of the digital camera 10, such as the one shown in FIG. 1. The camera 10 in this example includes a lens 11, an aperture 12, and a shutter 14. The aperture 12 may be adjusted using an aperture control 13. The shutter 14 is activated by a shutter control 15 to capture an image 1. As used herein, a shutter 14 refers to any device used to control exposure time of a sensor to a scene. A shutter 14 may include, for example, a mechanical shutter or an electronic shuttering device. A color filter 16, such as a Bayer pattern filter, may be used to filter colors in the image 1. A sensor 17, such as a charge-coupled device (CCD) or a complementary metal oxide semiconductor (CMOS) sensor, captures the final image 1 when the shutter control 15 is depressed. In one embodiment, the shutter 14 also allows the sensor 17 to sense the image 1, or a portion of the image 1, automatically when the camera 10 is in use, even before the shutter control 15 is activated to capture a final image 1. For example, the shutter 14 may be an electronic shuttering device. This allows the sensor 17 to detect the image 1 and display it on the display 30 so that the user 90 can view the image 1 to be captured.

An analog-to-digital converter (ADC) 18 converts the image 1 to digital data to be processed by a central processing unit (image processor) 20. In some embodiments, the sensor 17 includes functionality to convert the sensed image 1 to digital data, while in other embodiments, the sensor 17 and the ADC 18 may be separate.

The image processor 20 processes the image data to create the picture. The image processor 20 includes a color-balancing portion 24 that color balances the image 1. In use, the image processor 20 balances the color of the image 1 sensed by the sensor 17 before the final image 1 is captured, to display a color-balanced image 1 on the display 30. Once color balance parameters are finally set, as described herein, and the final image 1 is captured using the shutter control 15, and the image processor 20 applies the color balance parameters to the captured image 1.

In the example shown in FIG. 2, the image processor 20 includes portions that apply de-mosaic 22, color balance 24, and tone reproduction 26 algorithms to the raw image data received from the sensor 17. Various methods and systems are known for de-mosaicing, color balancing, and tone reproduction, and may be used in conjunction with the method and system described herein. The de-mosaic portion 22 creates a true color image 1 from the raw data received from the sensor 17. The tone reproduction portion 26 enhances and suppresses certain colors to create a desired image 1. The image processor may implement these functions in hardware or software. For example, the image processor 20 may be a central processing unit (CPU) that implements the color balancing and other functions in software embedded in the CPU. In other embodiments, the image processor 20 may be implemented in a digital signal processor (DSP), in a dedicated application specific integrated circuit (ASIC), or in other hardware. In some embodiments, these algorithms may be applied in separate portions or steps, while in other embodiments, one or more of these functions 22, 24, 26 may be combined.

For example, the color balancing function 24 may be combined with the de-mosaic and/or tone reproduction functions 22, 26. Still other embodiments of the image processor 20 may not include the de-mosaic and/or tone reproduction functions 22, 26. In the example shown in FIG. 2, the de-mosaic, color balance, and tone reproduction portions 22, 24, 26 are applied first to the sensed image 1 during an interactive or preview mode. The color-balanced image 1 is displayed on the display 30 so that the user 90 can view the image 1 and adjust the color balance before capturing the final image 1. In the embodiment shown, when the user 90 finishes adjusting color balance and captures the final image 1 using the shutter control 15, the image processor 20 processes the captured image 1 using the de-mosaic, color balance, and tone reproduction portions 22, 24, 26 of the image processor 20. When the image 1 is first processed by the image processor 20, before the user 90 has adjusted the color balance using the user input device 50 as described herein, the image processor 20 may perform a default or initial color balance using conventional methods.

The image 1 sensed by the image processor 20 is sent to the display 30 for viewing by the user 90 in an interactive mode before the image 1 is captured (also referred to as a preview mode). The image processor 20 receives the sensed image 1 from the sensor 17 and balances the color. The color-balanced image 1 is sent to a display 30 for viewing by a user 90. While viewing the display the user 90 adjusts the color balance using a user input device 50. In one embodiment, a color balance menu may appear on the display 30, for example overlaying the displayed image 1, and the user input device 50 may control a cursor displayed on the menu to adjust the color balance. The user input device 50 sends a signal to the image processor 20. The signal adjusts color balance parameters used by the image processor 20 to balance the color of the image 1. Using the adjusted color balance parameters, the image processor 20 adjusts the color balance of the image 1 and sends the adjusted color-balanced image 1 to the display 30. The display 30 shows the image 1 in real time such that the displayed image 1 is continuously updated as the user 90 adjusts the user input device 50. The process of adjusting the color balance and displaying the adjusted image 1 continues until the user determines that the color balancing is complete. The user 90 then operates the shutter control 15 to capture the final image 1, which is then processed in a capture mode by the image processor 20 according to the color balance parameters finally set by the user input device 50 during the interactive mode. The final color-balanced image 1 may be stored to memory. The captured image 1 may also be displayed on the display 30.

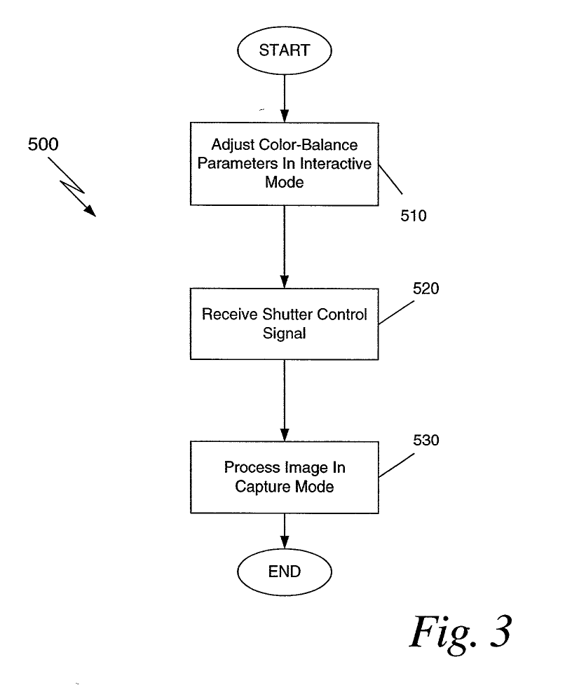

FIG. 3 shows a flow chart of a method 500 used by the camera 10 to color balance images 1. Color balance parameters used by the image processor 20 to balance the color are adjusted 510 in an interactive mode. In this mode the image 1, or a portion of the image 1, is sensed by the sensor 17 and displayed on the display 30. The user 90 adjusts the color balance using the user input device 50, while viewing the adjusted image in real time. In one embodiment, in interactive mode 510 the sensor 17 continuously senses the image 1, for example using an electronic shutter 14. In this embodiment, the displayed image 1 changes as the scene changes; for example, if a person entered the scene or if the camera 10 is moved, then the displayed image 1 would change. The display 30 displays the current image 1, functioning much like a view finder on a film-based camera. The image 1 displayed on the display 30 is color balanced as adjusted by the user 90. When the user 90 has completed color balancing the scene, the user 90 activates the shutter control 15. The camera 10 receives 520 a shutter control signal from the shutter control 15 causing the camera 10 to enter a capture mode 530 to process the image 1. In the capture mode 530, the sensor 17 captures the displayed image 1. An image processor 20 adjusts the color balance of the captured image 1 according to the color balance settings, also referred to as parameters, selected by the user input device 50 during the interactive mode 510. After processing, the captured image 1 may be stored to memory 40.

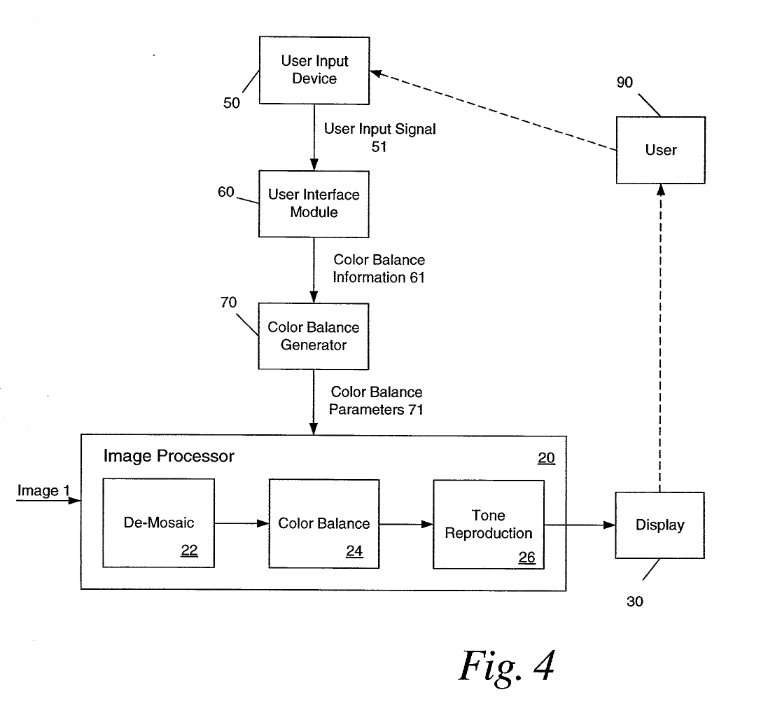

FIG. 4 shows a more detailed block diagram of one embodiment of the color-balancing process shown in FIG. 2, as performed during the interactive mode 510. In the example of FIG. 4, the image processor 20 has portions that de-mosaic 22, color balance 24, and apply a tone reproduction function 26 to the image 1 received from the sensor 17. These functions 22, 24, 26 may be separate, or two or more of them may be combined. The image 1 processed by the image processor 20 is displayed on a display 30. While viewing the display 30, the user 90 adjusts the color balance using a user input device 50. Based on the user's manipulation, the user input device 50 sends a user input signal 51 to a user interface module 60. The user interface module 60 translates the user input signal 51 to color balance information 61 that is used by the camera 10 to balance the image 1. For example, if the user input device 50 is a four-way rocker, then the user interface module 60 knows that depressing the switch 50 in a given direction for a given period of time causes a particular color balance change. The color balance information reflects the color balance change caused by the user input device 50 and is sent to a color balance generator 70 in this example. A color balance generator 70 receives the color balance information 61 from the user interface module 60 and generates color balance parameters 71. These parameters 71 are the data used by the image processor 20 to balance the color in the image 1.

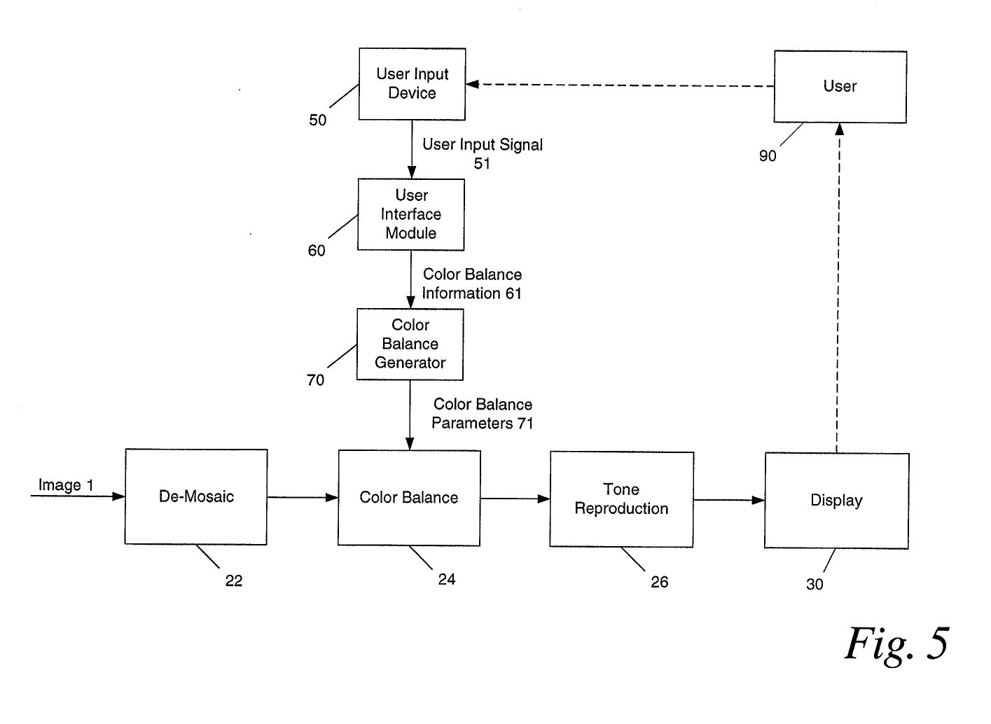

FIG. 5 shows a block diagram of another implementation of a color balance method. The embodiment of FIG. 5 shows the color balancing as performed during an interactive mode 510. In this example, the demosaic, color balance, and tone reproduction portions 22, 24, 26 of the image processor 20 are separate. The color balance generator 70 sends the color balance parameters 71 directly to the color balance portion 24 of the image processor 20.

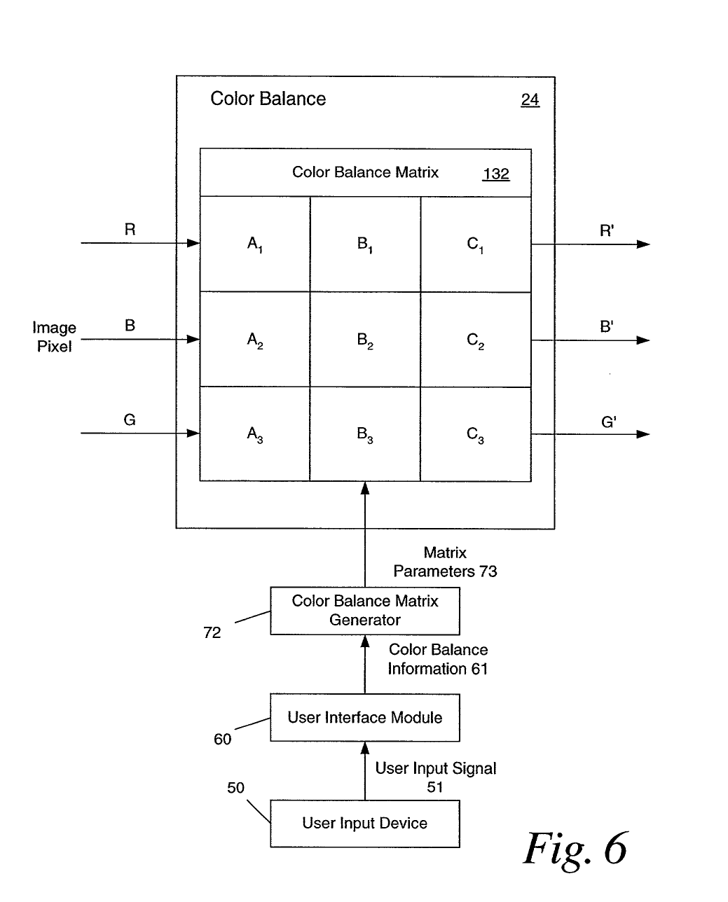

FIG. 6 shows one implementation of the color balance method 24 according to the embodiment shown in FIG. 5. The color balance matrix 132 in this example receives R, B, and G components of image data for pixels in the image 1. The outputs of the color balance portion 24 are color-balanced RBG components R′, B′, G′ of the pixels. By way of example using the parameters shown in the matrix 132 of FIG. 6, the outputs of the color balance matrix are the color components R′, B′, G′ given by the equations R′=A₁R+A₂G+A₃B; G′=B₁R+B₂G+B₃B; B′=C₁R+C₂G+C₃B. Before adjustment by the user 90, the matrix 132 may use initial or default values for the matrix parameters. Using the user input device 50, the user 90 adjusts the color balance of the image 1 by changing the matrix parameters, in this example. The user input device 50 sends the user input signal 51 to a user interface module 60 that translates the signal 51 into color balance information 61 that is sent to a color balance matrix generator 72. The color balance matrix generator 72 generates changes the color balance of the image 1 by generating color balance parameters, in this example matrix parameters 73 based on the color balance information 61. The matrix parameters 73 generated are sent to the color balance matrix 132. In one example, the matrix parameters 73 are directly input into the color balance matrix 132.

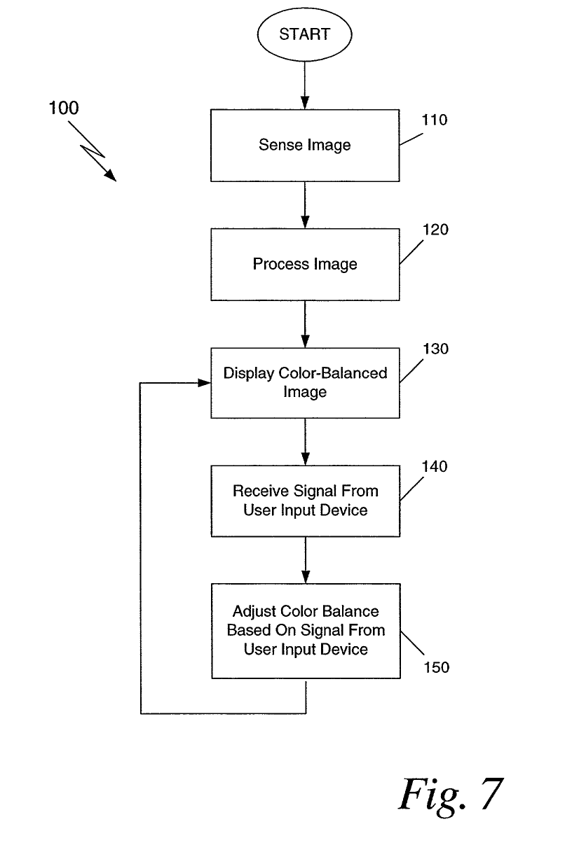

FIG. 7 shows a flow chart of a color balance method 100 performed during an interactive mode 510. The image 1 is sensed 110 using a sensor 17. The image 1 is processed 120 using an image processor 20 that applies a color balance. The color-balanced image 1 is displayed 130 on a display 30 for viewing by a user 90. The camera receives 140 a user input signal 51 from a user input device 50. Based on the signal received 51, the color balance of the image 1 is adjusted 150. The adjusted image 1 is then displayed 130. The process of displaying 130, receiving 140 a user input signal 51, and adjusting 150 the color balance continues until the color balancing is complete. The color-balance adjusted image 1 may be displayed 130 in real time so that the user 90 has immediate feedback of the changes to the color balance.

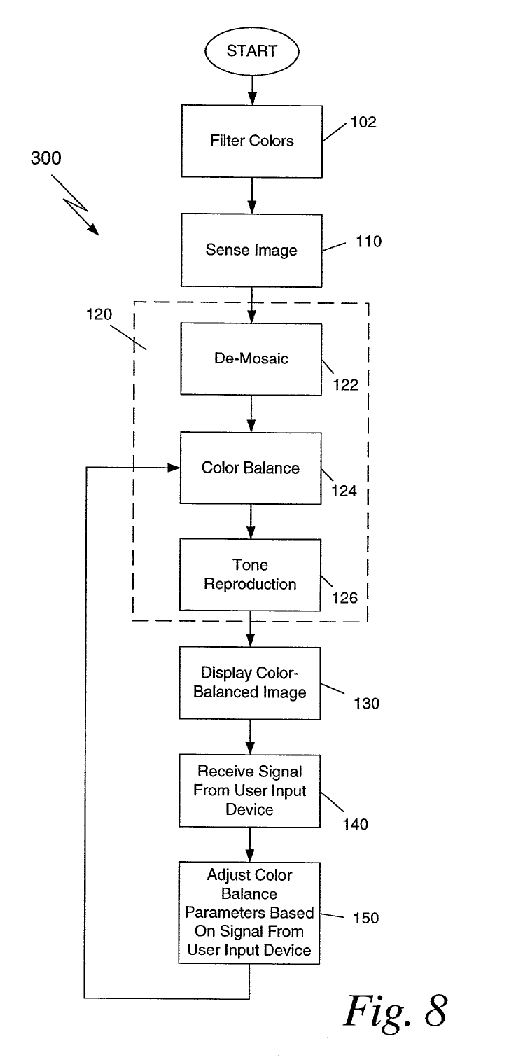

FIG. 8 shows a more detailed flow chart of one implementation of the method shown in FIG. 7 in which the image processor 20 also applies de-mosaic and tone reproduction algorithms to the image. Colors in a scene are filtered 102, for example using a Bayer pattern filter. A sensor 17 senses 110 the image 1. The image 1 is processed 120 by an image processor 20 by de-mosaicing 122 the image 1, color balancing 124 the image 1, and tone reproducing 126 the image 1. The color-balanced image 1 is displayed 130 on a display 30. A signal is received 140 from a user input device 50 adjusting the color balance. Based on the received signal, the color balance parameters are adjusted 150. The image 1 is then processed by color balancing the image using adjusted color balance parameters and by tone reproducing 126 the image 1, and displaying 130 the image 1 in real time, so that the user 90 can view the color balance adjustments as they occur.

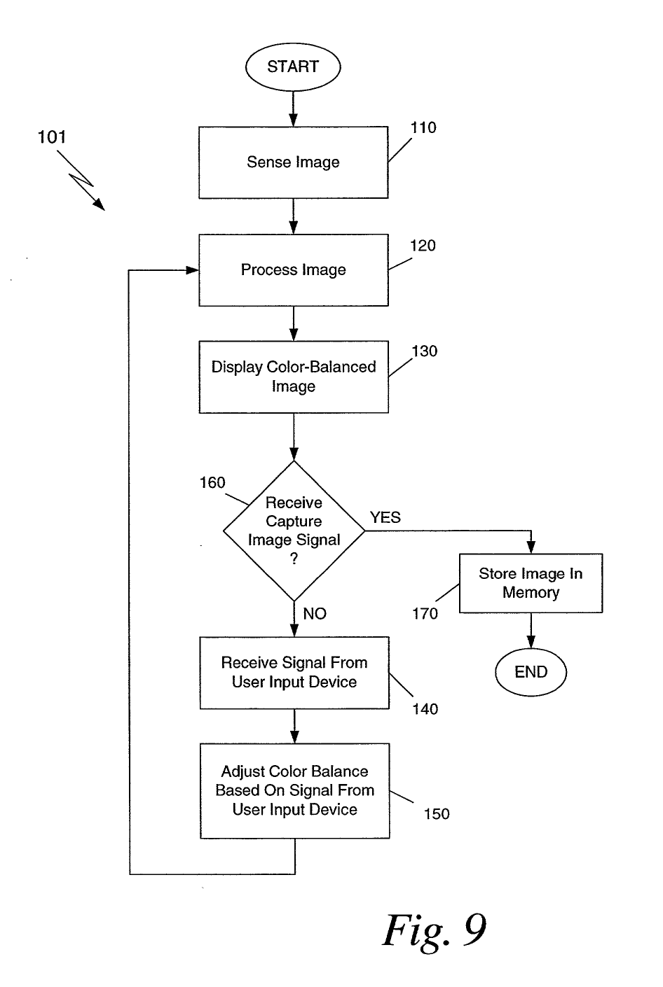

FIG. 9 shows a more detailed flow chart of one embodiment of the method shown in FIG. 7 including steps performed during an image capture mode 530. The method 101 shown in FIG. 9 shows not only the interactive mode 510 functions, but also the receiving of the shutter control signal 520 and an implementation of the capture mode 530. The image 1 is sensed 110, processed initially 120, and displayed 130 on the display 30. When the user 90 has balanced the color of the scene and is ready to capture the image 1, the user 90 activates the shutter control 15 sending a capture-image signal to the sensor 17, which causes the sensor 17 to capture the displayed image 1. The camera determines whether a capture-image signal has been received 160. If the signal is received, then the color-balanced image 1 is stored in memory 170 as part of a capture mode 530. Until the capture-image signal is received the image processor 20 continues to receive 140 signals 51 from the user input device 50 as the user 90 continues to manipulate the user input device 50 to adjust the color balance. The color balance of the displayed image 1 is adjusted 150 based on the signal 51 received from the user input device 50, and the adjusted image 1 is displayed on the display 30.

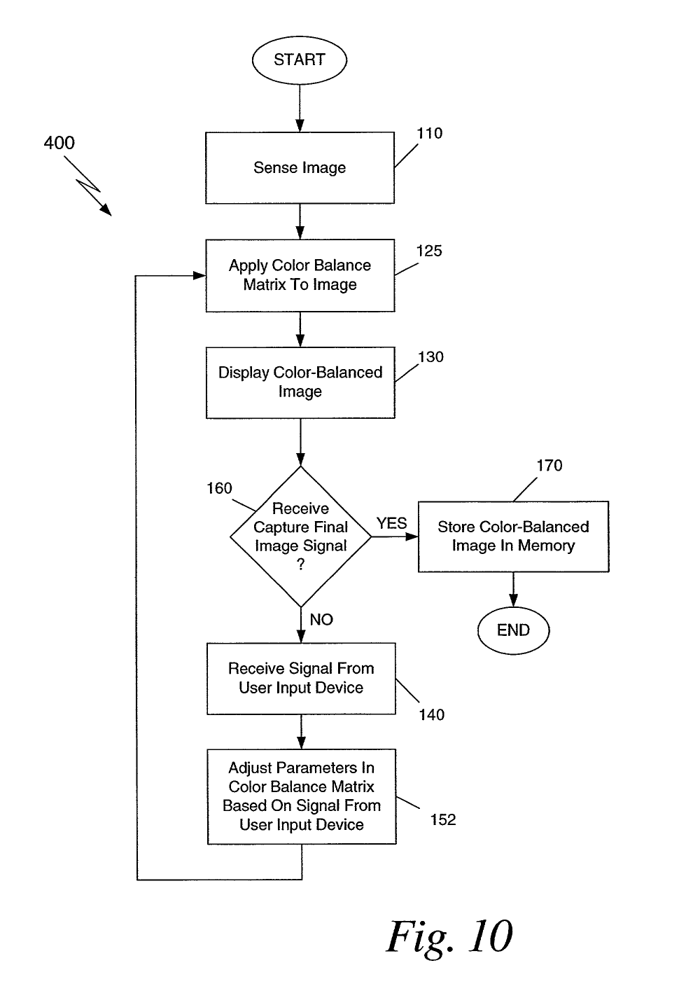

FIG. 10 shows a more detailed flow chart of one embodiment of a color balance method 400 according to the embodiment shown in FIG. 9 that might be implemented in a system that uses a color balance matrix 132 to adjust the color balance, such as that shown in FIG. 6,. An image 1 is sensed 110 by a sensor 17 and sent to a color balance portion 24 of the image processor 20. A color balance matrix 132 is applied 125 to the image 1. During the initial processing, before the user 90 has adjusted the color balance matrix 132, the matrix parameters may be initial or default parameters that approximate the color balance. The image 1 is displayed 130 on a display. The method 400 determines whether a capture-image signal has been received 160. When the capture-image signal is received, the color-balanced image 1 is stored 170 in memory 40. Until the capture-image signal is received, the color balance portion 24 of the image processor continues to receive 140 a user input signal 51 from a user input device 50. Based on the user input signal 51, the parameters of the color balance matrix 132 are adjusted 152. The matrix 132, with its newly adjusted parameters, is again applied 125 to the image 1, and the image 1 is sent 130 to the display 30.

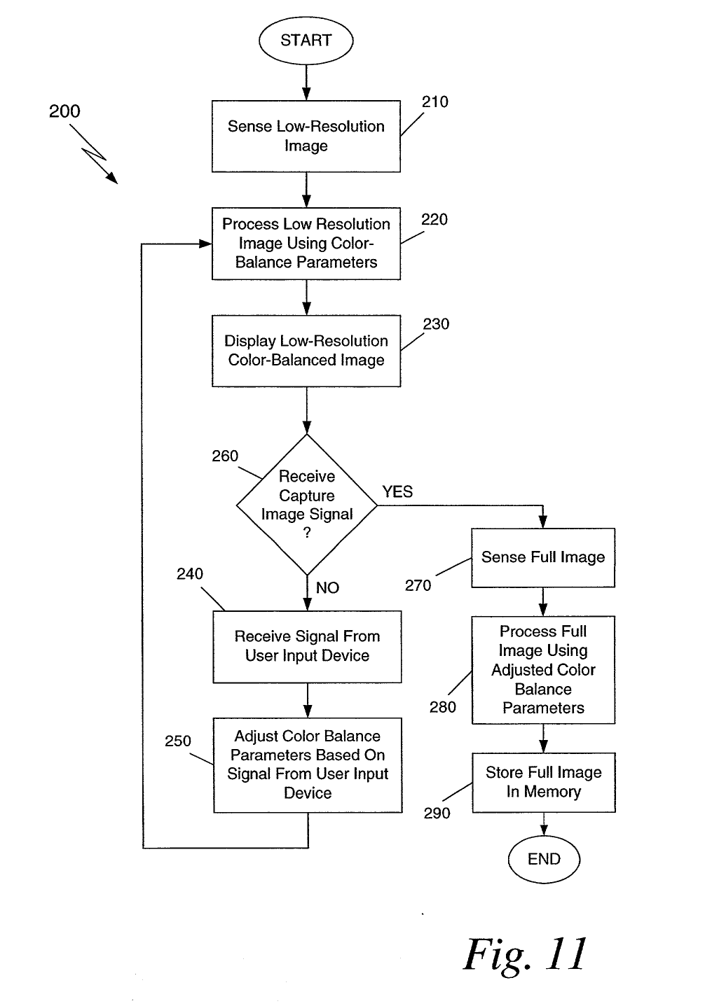

FIG. 11 illustrates a flow chart of a color balance method that processes a low resolution image 1 in the interactive mode 510 and applies the color balance parameters to a full image 1 in a capture mode 530. The method 200 shown in FIG. 11 processes a low-resolution image 1 during the interactive mode 510 and applies color balance settings set during the interactive mode 510 to a full image 1 captured during a capture mode 530. In this embodiment, during the interactive mode 510 the image 1 is sensed 210 by the sensor 17 at a low resolution, also referred to as a partial image 1. As used herein, low-resolution image refers to any image other than the highest quality image obtainable by the camera 10. It may include, for example, preview images displayed on displays of conventional digital cameras for allowing the user 90 to view the image 1 before capturing it. The low-resolution image 1 is processed 220 by the image processor 20, which color-balances the image 1. The low-resolution image 1 is then displayed 230 on the display 30. Various means are known for sensing 210 and displaying 230 a low-resolution image 1 including, for example, sensing the image 1 using fewer than all of the available photosites on the sensor 17, processing fewer than all of the pixels sensed by the sensor 17, combining or skipping entire lines of pixels, averaging pixel values, using decreased exposure time, or otherwise sub-sampling the image 1. The method 200 also determines whether a capture-image signal has been received 260 from a shutter control indicating that the color is properly balanced and that the image 1 should be captured, processed, and stored to memory 40. Until the capture-image signal is received, the image processor 20 continues to receive 240 the user input signal 51 from the user input device 50 and continues to adjust 250 the color balance parameters 71 of the low resolution image 1 based on the user input signal 51. As the color balance is adjusted, the image processor 20 continues to process 220 the low resolution image 1 using the adjusted color balance parameters.

When the capture-image signal is received, the sensor 17 senses the full image 270. As used herein, the term “full image” refers to the image that is captured by the camera 10 as a result of the use of the shutter control 15, and may or may not include an image captured at the maximum resolution available for the camera 10. The full image 1 is processed 280 by the image processor 20 using the color balance parameters adjusted by the user input device 50. The full image 1 is then stored 290 in memory 40.

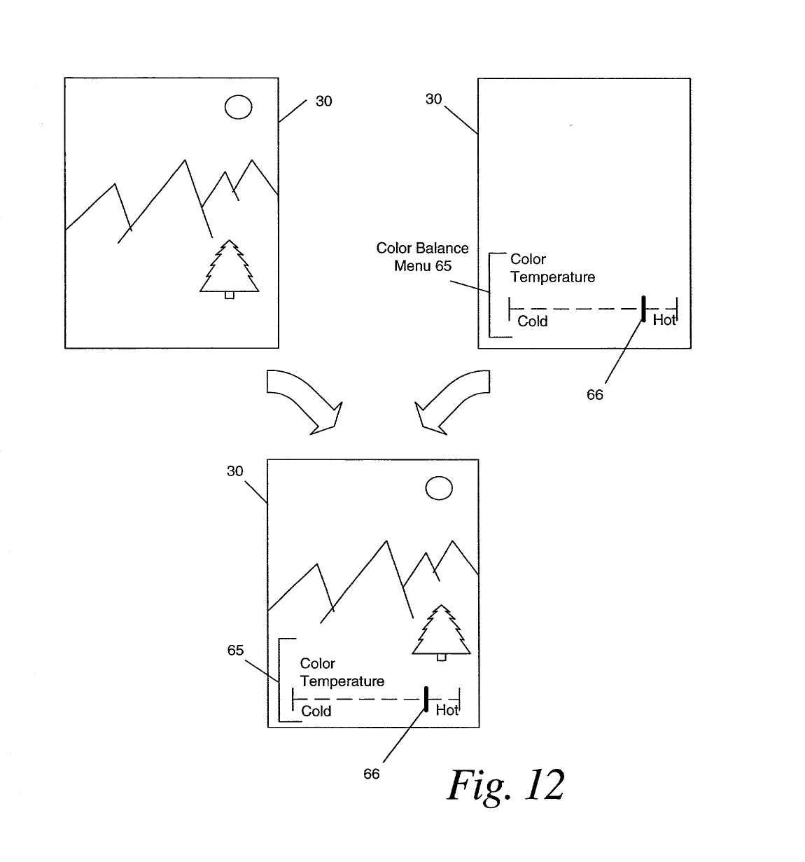

FIG. 12 shows one embodiment of a display 30 using an interactive color balance menu 65. The upper left portion of FIG. 12 shows an image 1 sensed by the sensor 17 and displayed on the display 30 during the interactive mode. In this embodiment, the user 90 adjusts the color balance using a color balance menu 65 shown in the upper right portion of FIG. 12. In one embodiment, the color balance menu 65 is displayed on the display 30 at the same time as the sensed image 1, either on a separate portion of the display 30 or overlaying the image 1 as shown in the bottom portion of FIG. 12, in which the menu 65 and image 1 are combined. The interactive menu 65 gives the user 90 a visual reference as the color balance is adjusted using the user input device 50.

In the example of FIG. 12, the menu 65 includes text and an adjustable scale. This simple example allows the user 90 to adjust the color balance based on color temperature. The menu 65 includes a scale ranging from cold to hot. A cursor 66 is shown on the scale and is responsive to the signal 51 received by the user input device 50. In this example, the user 90 may balance the scene to a cooler color balance with one movement of the user input device 50, for example depressing a rocker switch to the left, and may balance the scene to a warmer color balance with another movement. The cursor is responsive to the movement of the user input device 50, moving along the scale as the user 90 adjusts the color balance for temperature.

In other embodiments, the user input device 50 may change the color balance in more than just two directions - that is, other than simply moving between cooler and warmer color balances. In one embodiment, the color balance may be adjusted according to a color wheel, whereby the user 90 moves a cursor in two dimensions using a four-way rocker switch or similar control to make the color balance more or less red, blue, and/or green. The color wheel may be displayed on the display 30, overlaying the image 1 as shown in FIG. 12. Some embodiments may include multiple interactive menus that allow color balancing. For example, a user 90 may be able to manipulate color balance first using a color wheel and again using a temperature scale, displayed on one or more menus. The menus may be interconnected, and in one embodiment the user 90 may traverse the menus using the user input device 50. In still another embodiment, interactive menus might not be displayed on the display 30, and might not even be used. Instead, the user 90 may simply manipulate the user input device 50 and view the results on the display 50. Text or other instructions may be printed on or near the user input device 50 explaining how the user input device 50 changes the color balance. For example the user input device 50 might include a slider switch that varies the color balance from warm to cool.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

What is claimed:

1. A digital camera comprising:
a sensor that senses an image;
an image processor that color balances the image;
a display that displays the image; and
a user input device that sends a signal to the image processor, wherein the signal adjusts the color balance of the image while image is displayed on the display.

2. The camera of claim 1, wherein the signal sent by the user input device adjusts the color balance across a continuous color balance spectrum, wherein the color balance of the image may be varied gradually.

3. The camera of claim 1, wherein the image processor color balances the image using a color balance matrix, and wherein the signal sent from the user input device adjusts the color balance by adjusting parameters in the color balance matrix.

4. The camera of claim 1, wherein the image processor performs an initial color balance based on an initial color balance setting and thereafter adjusts the color balance based on the signal received from the user input device.

5. The camera of claim 1, further comprising an electronic shutter, wherein the shutter causes the sensor to receive the image during an interactive mode before the image is captured.

6. The camera of claim 1, wherein the image processor further comprises:
means to de-mosaic the image; and
means to tone reproduce the image.

7. The camera of claim 1, wherein the display displays an interactive color balance menu, the menu includes a cursor responsive to the user input device.

8. The camera of claim 7, wherein the display displays the color balance menu and the image at the same time.

9. The camera of claim 7, wherein the color balance menu includes a color temperature menu, and wherein the signal sent from the user input device adjusts the color balance based on color temperature.

10. The camera of claim 1, wherein:
during an interactive mode,
the sensor senses a low resolution image,
the image processor color balances the low resolution image, and
the display displays the low resolution image, and
during a capture mode,
the sensor senses a full image, and
the image processor color balances the full image using color balance parameters set during the interactive mode.

11. The camera of claim 10, further comprising a memory that stores the full image during the capture mode.

12. The camera of claim 10, further comprising a shutter control, wherein the shutter control sends a signal to the sensor to cause the sensor to capture the full image.

13. The camera of claim 1, further comprising:
a user interface module, wherein the module generates color balance information from the signal sent from the user input device; and
a color balance generator, wherein the generator generates color balance parameters from the color balance information.

14. The camera of claim 13, wherein the color balance generator generates parameters of a color balance matrix that is applied to the image by the image processor.

15. The camera of claim 14, wherein the color balance matrix is a3×3 matrix applied to color components of pixels in the image.

16. The camera of claim 14, wherein the color balance matrix is applied to the image by the image processor as part of a de-mosaic algorithm.

17. A method for color balancing a digital image comprising:
adjusting color balance parameters in an interactive mode;
receiving a shutter control signal indicating that an image should be captured; and
processing the image in a capture mode, wherein the step of processing includes step of using the adjusted color balance parameters to color balance the image.

18. The method of claim 17, wherein the step of adjusting comprises:
receiving the image from a sensor;
displaying the image on a display;
receiving a user input signal during the step of displaying; and
modifying the color balance parameters based on the user input signal.

19. The method of claim 18, wherein the steps of receiving and displaying the image comprise receiving and displaying a low-resolution image, respectively.

20. The method of claim 17, wherein the step of processing the image comprises:
sensing a full image;
processing the full image using an image processor that applies the adjusted color balance parameters to the full image; and
storing the image.

21. The method of claim 17, wherein the step of adjusting comprises:
displaying an interactive color balance menu on a display;
receiving a user input signal adjusting color balance based on the menu;
adjusting the color balance parameters based on the user input signal;
applying the adjusted color balance parameters to the image; and
displaying the image on the display.

22. The method of claim 17, wherein the step of adjusting comprises adjusting parameters of a color balance matrix that is applied to the image.

23. A method, comprising:
sensing a low resolution image using a sensor;
processing the low resolution image using color balance parameters;
displaying the color-balanced low-resolution image on a display;
receiving a signal from a user input device;
adjusting the color balance parameters based on the signal;
processing the low resolution image using the adjusted color balance parameters; and
displaying the adjusted color-balanced low resolution image on the display.

24. The method of claim 23, further comprising:
receiving an image-capture signal;
sensing a full image after receiving the image-capture signal;
processing the full image using the adjusted color balance parameters to color balance the image; and
storing the image in memory.

25. The method of claim 24, wherein the steps of receiving the signal from the user input device, adjusting the color balance parameters, processing the low resolution image, and displaying the adjusted color-balanced low-resolution image further comprises:
receiving the signal from the user input device;
adjusting the color balance parameters;
processing the low resolution image; and
displaying the adjusted color-balanced low-resolution image until the capture-image signal is received.

26. The method of claim 23, wherein the step of processing the low-resolution image further comprises applying a de-mosaic algorithm to the low-resolution image.

27. The method of claim 23, further comprising applying a tone reproduction algorithm to the low-resolution image.

28. A digital camera that operates in an interactive mode to adjust color balance of an image and in a capture mode for capturing the image after the color balance is adjusted, the camera comprising:
a sensor to sense a low resolution image during an interactive mode and senses a full image during a capture mode;
an image processor to color balance the low resolution image during the interactive mode and color balances the full image during the capture mode;
a user input device to adjust the color balance of the low resolution image during the interactive mode by sending a signal to the image processor, wherein the signal is used to create color balance parameters that are applied to the lower resolution image by the image processor;
a display displays the low resolution image in real time, while the user input device adjusts the color balance; and
a shutter control to cause the camera to capture the image after the color balance has been adjusted, wherein during the image capture mode the image processor applies the color balance parameters set during the interactive mode to the full image.

29. The camera of claim 29, further comprising means to generate a color balance menu displayed on the display, wherein the user input device adjusts the color balance using the menu.

30. The camera of claim 28, wherein the image processor applies a color balance matrix to color components of pixels to color balance the images, and wherein the signal from the user input device adjusts parameters of the color balance matrix.
